(19) United States
(12) Patent Application Publication
(10) Pub. No.: US 2005/0013132 A1
(43) Pub. Date: Jan. 20, 2005

(54) Illumination apparatus employing auxiliary light source and projection system including illumination apparatus

(75) Inventors: Dae-sik Kim, Gyeonggi-do (KR); Kun-ho Cho, Gyenggi-do (KR); Sung-ha Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/853,704

(22) Filed: May 26, 2004

(30) Foreign Application Priority Data
May 27, 2003 (KR) 2003-33849

(51) Int. Cl. F21V 9/00

(52) U.S. Cl. 362/231; 362/230; 362/227; 362/244; 362/240; 362/245; 362/309; 362/800; 362/31; 362/30

(57) ABSTRACT

Provided are an illumination apparatus employing an auxiliary light source and a projection system therewith. The illumination apparatus includes a main light source unit for emitting white light, and an auxiliary light source unit for introducing auxiliary light of a predetermined wavelength band to a space in which the light intensity of the main light source unit is low to increase the intensity of the white light. The illumination apparatus can uniformly control a spatial light intensity distribution and a band light intensity distribution, and enlarge a color reproduction area and provide a high quality image with high luminous efficiency.

### BACKGROUND OF THE INVENTION

This application is based upon and claims the benefit of priority from Korean Patent Application No. 2003-33849, filed on May 27, 2003, in the Korean Intellectual Property Office, the disclosure of which is incorporated herein in its entirety by reference.

1. Field of the Invention

The invention relates to an illumination apparatus and a projection system, and more particularly, to an illumination apparatus employing an auxiliary light source and a projection system comprising the illumination apparatus.

2. Description of the Related Art

FIG. 1 is a schematic diagram illustrating a structure of a light source employed by a related art projection system. Referring to FIG. 1, a light source 2 includes a lamp 5 and a parabolic reflector 9. The lamp 5 is a mercury, xenon, or metal halide lamp. A light beam, which is emitted from the lamp 5, diverges in a space between the lamp 5 and the parabolic reflector 9 of the light source 2.

FIG. 2 is a diagram and graphs illustrating the light intensity distribution of the light source 2 shown in FIG. 1. Referring to FIG. 2, since light is not emitted from a point on the lamp 5 where a central electrode is disposed, the position appears darker than other portions around it.

The light intensity distribution of the conventional light source is not a Gaussian distribution but an asymmetric light intensity distribution in which the light intensity at the central electrode decreases by as much as ⅕. In the light intensity distribution of the light source 2, a region with a lower intensity than others is called a dead zone. The light intensity distribution of the conventional light source suffers such spatial non-uniformity, and band non-uniformity, such that light in a predetermined wavelength band has a lower intensity than light in other wavelength bands.

To compensate for light which has a low intensity in a wavelength band, Japanese Patent Publication No. 2002-296680 discloses a display employing illumination light synthesizing means. FIG. 3 is a diagram illustrating a configuration of the display disclosed in the Japanese Patent Publication No. 2002-296680.

Referring to FIG. 3, a display 1 modulates light emitted from a light source 2 via liquid crystal display panels 3R, 3G, and 3B, and displays the modulated light on a screen 4. The light source 2 includes a main light source unit 6 and an auxiliary light source unit 8. The main light source unit 6 includes an ultra high performance (UHP) lamp 5 and a parabolic reflector 9. The auxiliary light source unit 8 includes an auxiliary light source 7 using a laser diode (LD) or a light emitting diode (LED). Also, the display 1 includes first and second fly-eye lenses 10a and 10b, a polarizer 12, first and second relay lenses 13 and 14, a color filter 17, a mirror 20, a condenser lens 21, a polarized light splitter 22, an analyzing surface 22a, and a color prism 23.

As shown in FIG. 4, since main light emitted from the main light source unit 6 in the conventional display 1 is lost in a band of 640-660 nm, auxiliary light emitted from the auxiliary light source 7 is additionally provided to compensate for the lost main light. However, the provision of such an auxiliary light source 7 increases the entire cost of the display 1.

In particular, the color filter 17 should be additionally provided as the illumination light synthesizing member in the display 1 to pass light within a wavelength band which is lost from the light emitted from the main light source unit 6 and pass all compensating light emitted from the auxiliary light source 7. However, it is difficult to manufacture such a color filter 17. Furthermore, the display 1 with the color filter 17 compensates for deficiencies in the spatial distribution but does not compensate for deficiencies in the light intensity distribution of light emitted from the UHP lamp 5.

### SUMMARY OF THE INVENTION

The invention provides an illumination apparatus employing an auxiliary light source which can increase light intensity without an additional color filter, and a projection system comprising the illumination apparatus which can realize a wide color reproduction with high illumination efficiency over a screen.

According to an aspect of the invention, there is provided an illumination apparatus comprising: a main light source unit for emitting white light; and an auxiliary light source unit for introducing auxiliary light of a predetermined wavelength band to a space where the light intensity of the main light source unit is low. This arrangement increases the light intensity of the white light and enlarges a color reproduction area.

According to another aspect of the invention, there is provided a projection system comprising: an illumination apparatus; an optical splitter for separating light emitted from the illumination apparatus into multiple-colored light; a display unit for modulating and imaging the multiple-colored light emitted from the optical splitter according to applied image signals; and a projector for projecting light emitted from the display unit on an enlarged scale onto a screen, wherein the illumination apparatus comprises: a main light source unit for emitting white light; and an auxiliary light source unit for introducing auxiliary light of a predetermined wavelength band to a space where the light intensity of the main light source unit is low. This arrangement increases the light intensity of the white light and enlarges a color reproduction area.

### BRIEF DESCRIPTION OF THE DRAWINGS

The above and other features and advantages of the invention will become more apparent by describing in detail exemplary embodiments thereof with reference to the attached drawings in which:

FIG. 1 is a schematic sectional view illustrating a configuration of an illumination apparatus of a related art projection system;

FIG. 2 is a diagram and graphs illustrating the light distribution of a light source shown in FIG. 1;

FIG. 3 is a diagram illustrating a configuration of a display disclosed in Japanese Patent Publication No. 2002-296680;

FIG. 4 is a graph illustrating changes in light intensity according to a wavelength of the display shown in FIG. 3;

FIG. 5 is a schematic sectional view of an illumination apparatus according to a first exemplary embodiment of the invention;

FIG. 6 is a graph illustrating the light intensity distribution according to an illumination position of the display shown in FIG. 5;

FIG. 7 is a graph illustrating the spectral distribution of the illumination apparatus shown in FIG. 5;

FIG. 8 is a schematic sectional view of an illumination apparatus according to a second exemplary embodiment of the invention;

FIG. 9 is a graph illustrating the spatial light intensity distribution of the illumination apparatus shown in FIG. 8;

FIG. 10 is a graph illustrating the light intensity distribution according to a wavelength of the illumination apparatus shown in FIG. 8;

FIG. 11 is a schematic sectional view of an illumination apparatus according to a third exemplary embodiment of the invention;

FIG. 12 is a perspective view of a first reflective prism of the illumination apparatus shown in FIG. 11;

FIG. 13 is a schematic sectional view of an illumination apparatus according to a fourth exemplary embodiment of the invention;

FIG. 14 is a perspective view of a second reflective prism of the illumination apparatus shown in FIG. 13;

FIG. 15 is a schematic sectional view of an illumination apparatus according to a fifth exemplary embodiment of the invention;

FIG. 16 is a graph illustrating the light intensity distribution of the illumination apparatus shown in FIG. 15;

FIGS. 17 through 19 are respectively a perspective view of a third reflective prism according to other embodiments of the illumination apparatus shown in FIG. 15;

FIG. 20 is a schematic sectional view of an illumination apparatus according to a sixth exemplary embodiment of the invention;

FIG. 21 is a top plan view of a reflecting mirror of the illumination apparatuses shown in FIG. 20;

FIG. 22 is a schematic sectional view of an illumination apparatus according to a seventh exemplary embodiment of the invention;

FIG. 23 is a schematic sectional view of an illumination apparatus according to an eighth exemplary embodiment of the invention; and

FIG. 24 is a schematic sectional view illustrating a configuration of a projection system according to a exemplary embodiment of the invention.

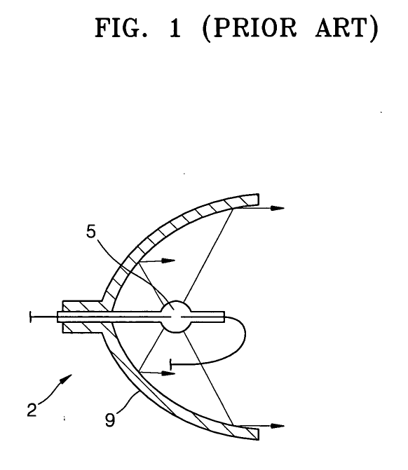

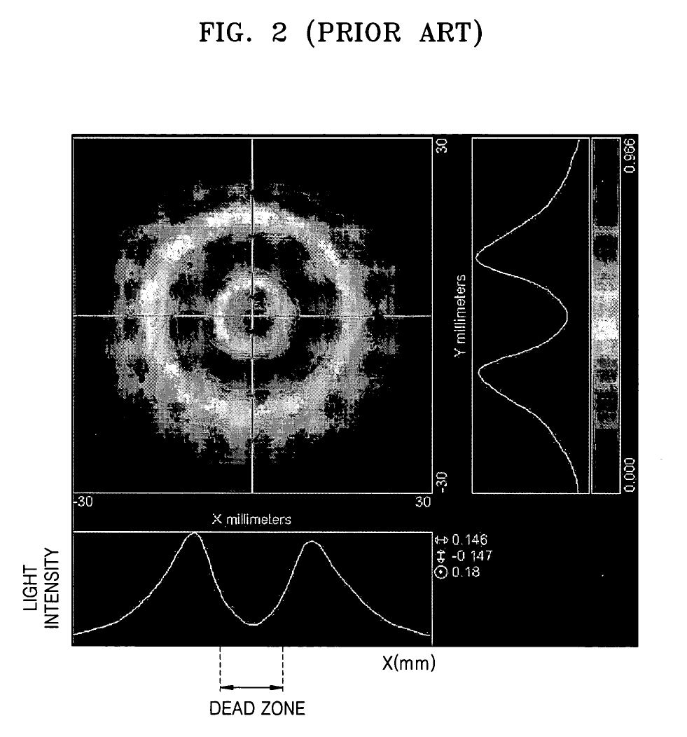

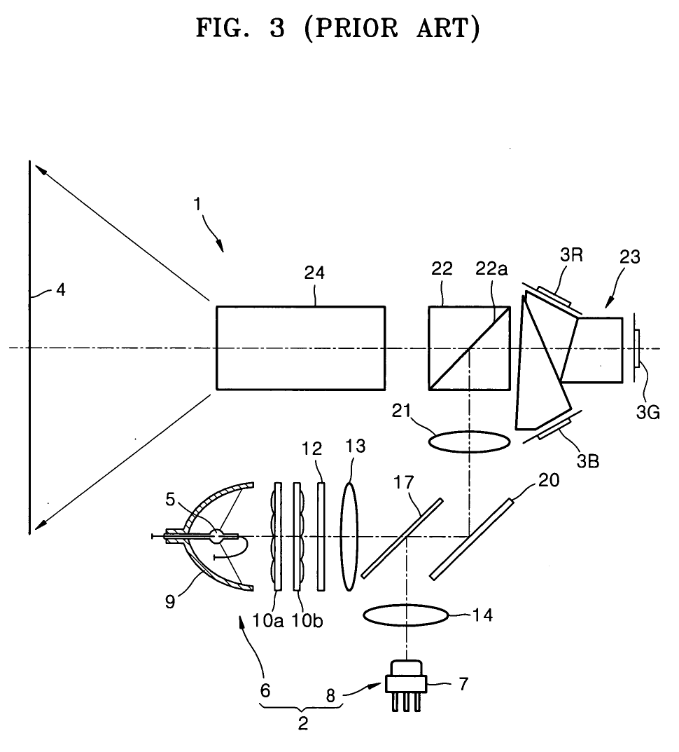

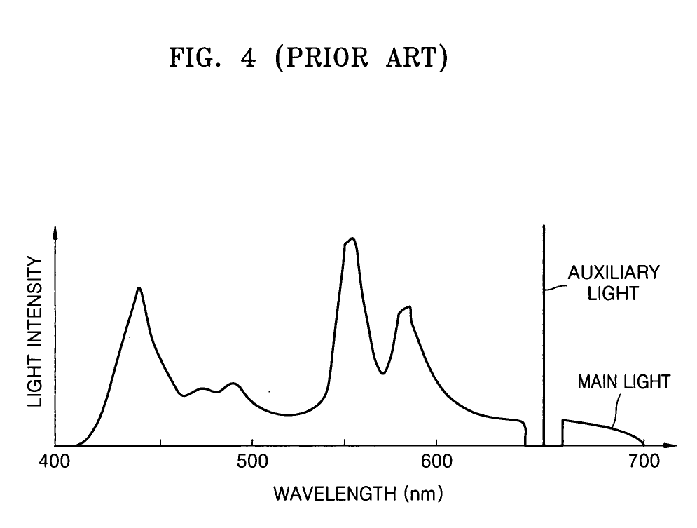

### DETAILED DESCRIPTION OF THE INVENTION

The invention will now be described more fully with reference to the accompanying drawings, in which exemplary embodiments of the invention are shown. The described exemplary embodiments are intended to assist the understanding of the invention, and are not intended to limit the scope of the invention in any way. The same reference numerals indicate the same elements throughout the drawings.

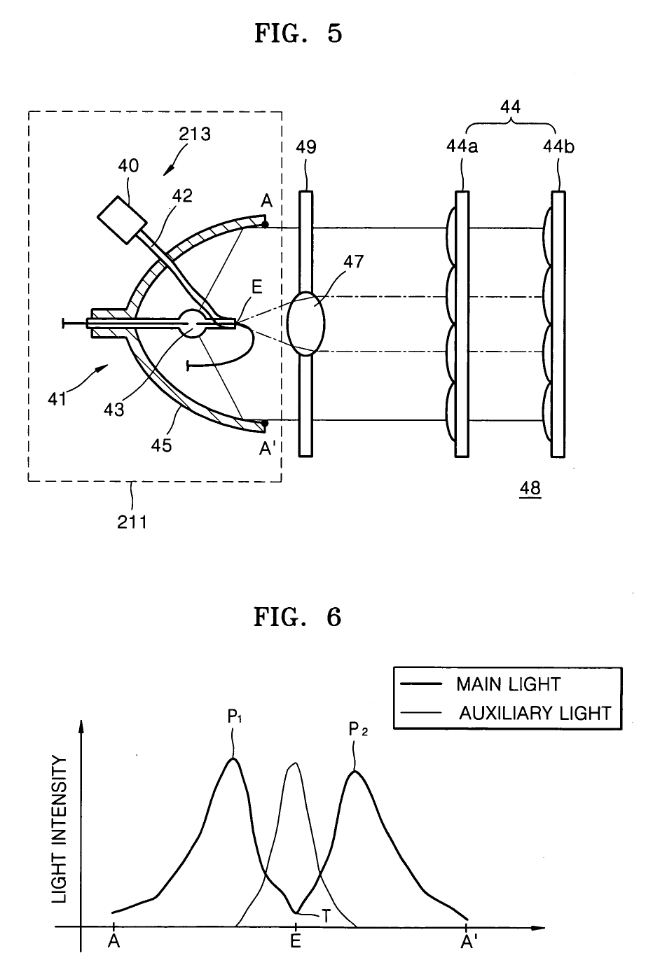

Referring to FIG. 5, an illumination apparatus 48 according to a first exemplary embodiment of the invention includes a light source section 211, an integrating section 44 including first and second integrators 44a and 44b for integrating a light beam emitted from the light source 211 into uniform light intensity distribution, an ultraviolet-cut filter 49, for cutting out ultraviolet light, disposed in the path between the light source section 211 and the integrating section 44, and a collimating lens 47, for collimating auxiliary light, disposed on a central portion of the ultraviolet-cut filter 49.

The light source section 211 includes a main light source unit 41 and an auxiliary light source unit 213. The main light source unit 41 includes a lamp 43 for producing white light, and a reflector 45 for reflecting the white light emitted from the lamp 43 along parallel paths. Here, the lamp 43 is disposed on a central portion of the reflector 45. The lamp 43 is a mercury, xenon, or metal halide lamp. The reflector 45 is an elliptical reflector or a parabolic reflector. Here, the light intensity of red light among the white light emitted from the lamp 43 is lower than the light intensity of other light and the light intensity from the point where an electrode E is positioned is much lower than from elsewhere on the lamp.

The auxiliary light source unit 213 includes an auxiliary light source 40 for emitting monochromatic light of a predetermined wavelength band with a high intensity, and a light guide 42 for guiding auxiliary light. The auxiliary light source 40 is a laser diode (LD) or a light emitting diode (LED). The light guide 42 is a wave guide or an optical fiber.

The auxiliary light source 40 may be installed directly to the electrode E of the lamp 43. In this case, the light guide 42 is excluded from components of the auxiliary light source unit 213. Also, the auxiliary light source 40 may be disposed outside the main light source unit 41 and connected to the electrode E by the light guide 42. In this case, the light guide 42 guides the auxiliary light emitted from the auxiliary light source 40 and emits the auxiliary light along the same path as that of the white light from the lamp 43.

Referring to FIG. 6, the intensity of the main light has two peaks P1 and P2 between points A and A′ and a trough at the position of the electrode E. The trough in the light intensity distribution of the main light is compensated by auxiliary light emitted from the auxiliary light source 40.

Referring to FIG. 7, the main light shows peaks in the blue and green regions at the spectrum, and a trough in the red region. That is, an image formed on a screen using only the main light source unit 41 will be deficient in red light. It is caused by the non-uniform distribution of the spectral intensity of the main light. However, if the auxiliary light source unit 213 emitting red light is provided, the spectral intensity at the wavelength band of the red light is reinforced such that uniform light intensity can be achieved at all the wavelength bands of red, green and blue lights.

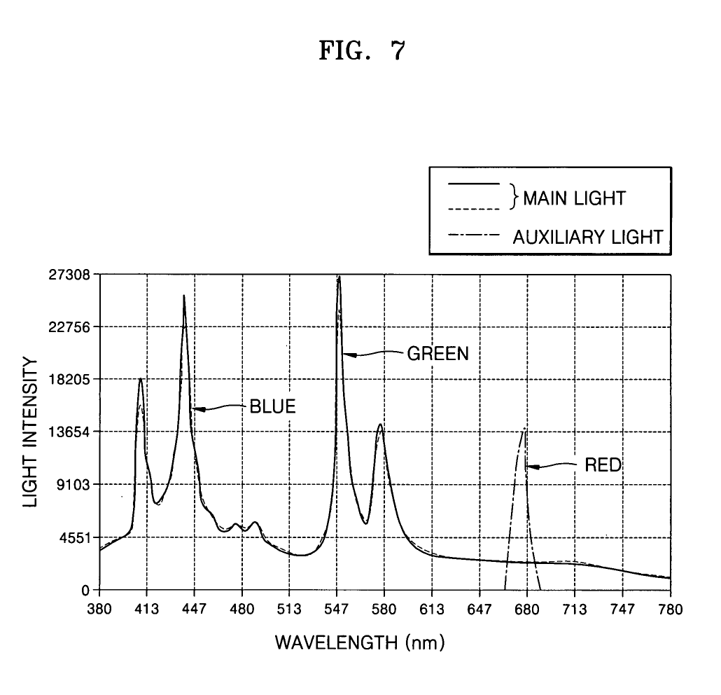

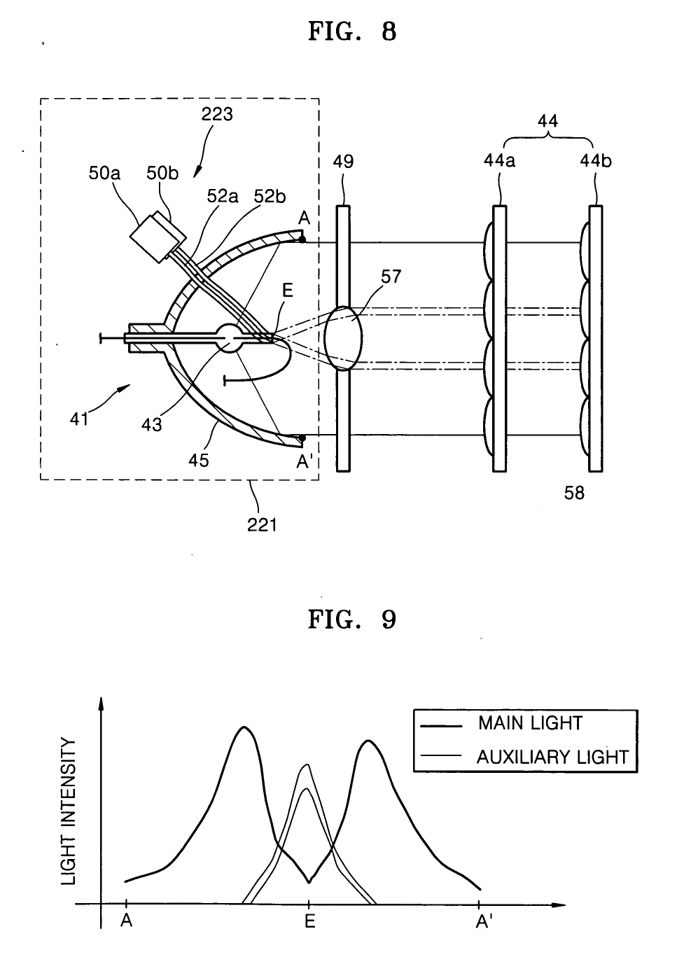

Referring to FIG. 8, an illumination apparatus 58 according to a second exemplary embodiment of the invention is similar to the illumination apparatus 48 shown in FIG. 5 except that a light source section 221 includes an auxiliary light source unit 223 including first and second auxiliary light sources 50a and 50b, and first and second light guides 52a and 52b.

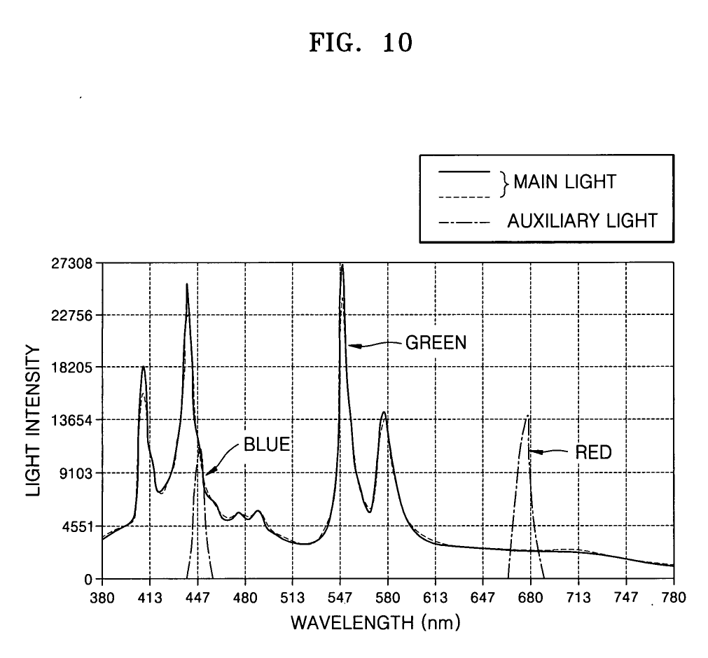

The first and second auxiliary light sources 50a and 50b respectively emit the first and second auxiliary lights which have different wavelength bands. The first and the second auxiliary lights proceed in a superimposed state to the position of an electrode E where the main light is lost as shown in FIG. 9. Further, the first and second auxiliary light sources 50a and 50b use an LD or an LED which emits blue light and red light. When the first and second auxiliary light sources 50a and 50b are disposed outside the main light source unit 41, the first and second light guides 52a and 52b are employed as components of the auxiliary light source unit 223. The first and second light guides 52a and 52b respectively guide first and second auxiliary lights from the first and second auxiliary light sources 50a and 50b to the electrode E. Accordingly, the illumination apparatus 58 reinforces the spectral intensity in the red and blue regions as shown in FIG. 10.

Referring to FIG. 11, an illumination apparatus 68 according to a third exemplary embodiment of the invention includes a light source section 231 and an integrating section 44. The light source section 231 includes a main light source unit 41 and an auxiliary light source unit 233 which emits auxiliary light perpendicular to the path of main light emitted from the main light source unit 41.

The auxiliary light source unit 233 includes an auxiliary light source 60 emitting the auxiliary light, a collimating lens 67 disposed in the path of the auxiliary light for collimating the auxiliary light, and a first reflective prism 66 acting as a path changing member. The auxiliary light source 60 is disposed at one side of the main light source unit 41 to be preferably as close to the main light source unit 41 as possible. The first reflective prism 66 changes the path of the auxiliary light from perpendicular to parallel to the main light so that the main light and the auxiliary light follow the same path.

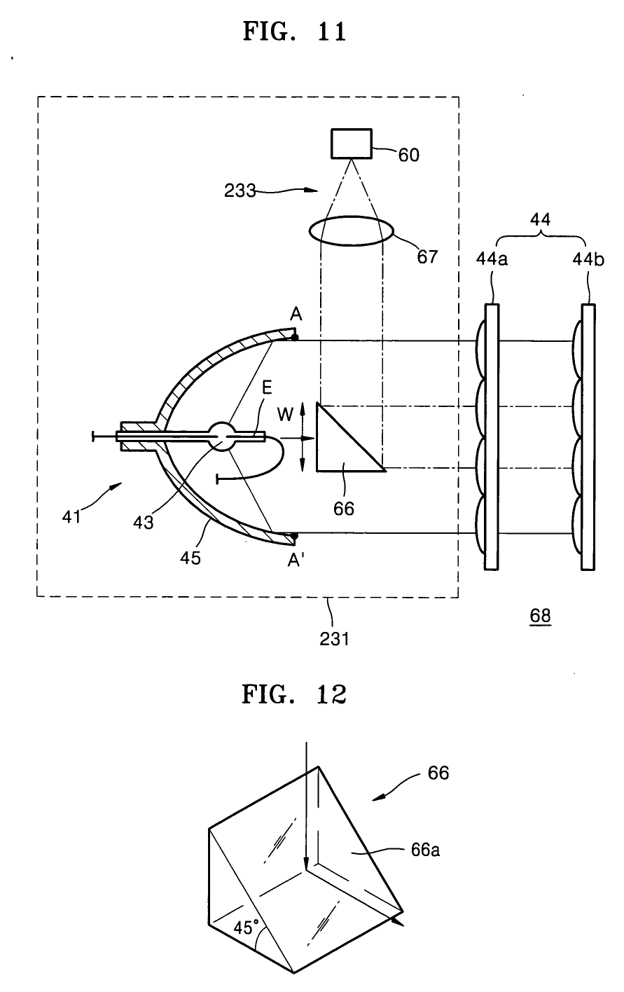

Referring to FIG. 12, the first reflective prism 66 is a rectangular prism having a reflecting surface 66a of degrees to reflect the single auxiliary light emitted from the auxiliary light source 60.

In FIG. 11, it is preferable, but not necessary, that the reflective prism 66 has a width W as wide as a dead zone of the main light source unit 41. Since the intensity of the light emitted from the electrode E of the main light source unit 41 is very weak, a portion of the main light reflected by the first reflective prism 66 can be ignored. The light intensity in the dead zone can be increased by employing the reflective prism 66 that is as wide as the dead zone. Therefore, the illumination apparatus according to the third exemplary embodiment of the invention controls the light intensity distribution by focusing the auxiliary light on the dead zone of the main light source unit 41 and controls the spectral intensity by properly selecting the auxiliary light source 60.

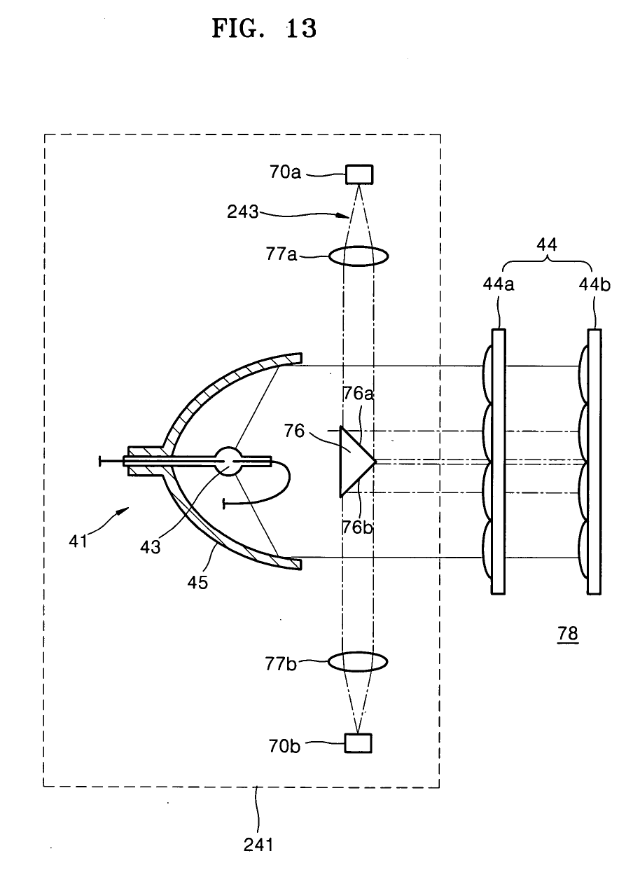

Referring to FIG. 13, an illumination apparatus 78 according to a fourth exemplary embodiment of the invention is similar to the illumination apparatus 68 shown in FIG. 11 except that a light source section 241 includes an auxiliary light source unit 243 including first and second auxiliary light sources 70a and 70b. The first and second auxiliary light sources 70a and 70b are disposed to face each other with a main light beam therebetween. The first and second auxiliary light sources 70a and 70b respectively emit first auxiliary light and second auxiliary light perpendicular to the path of the main light emitted from the main light source unit 41. A second reflective prism 76 having a first surface 76a to reflect the first auxiliary light and a second surface 76b of 45 degrees to reflect the second auxiliary light is disposed in the path of the main light between the first and second auxiliary light sources 70a and 70b. First and second collimating lenses 77a and 77b are further disposed respectively in the paths of the first and second auxiliary light sources 70a and 70b and the second reflective prism 76 to collimate the auxiliary lights.

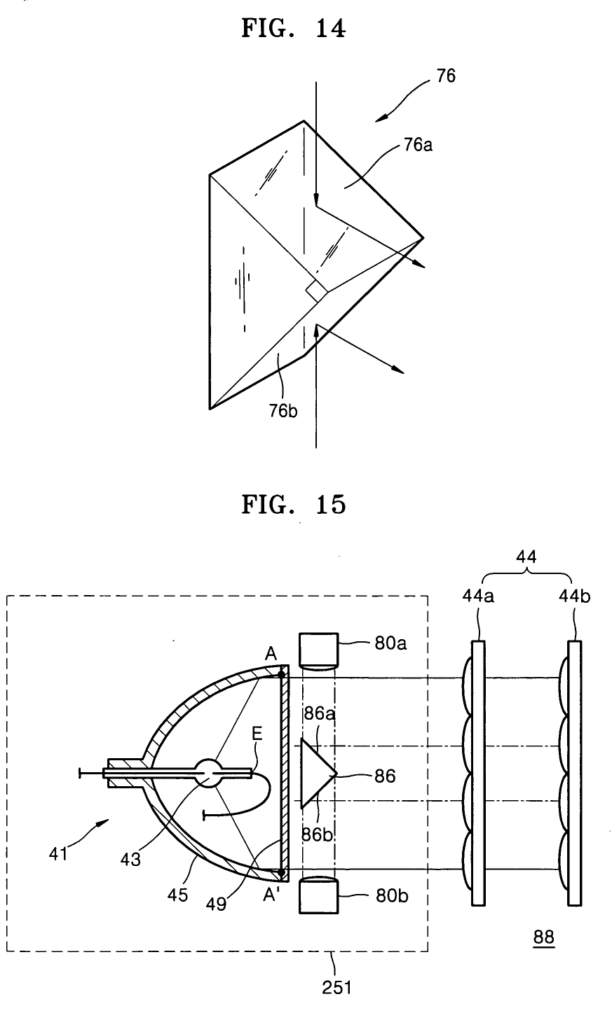

Referring to FIG. 14, an isosceles triangular prism is employed as the second reflective prism 76 to reflect the first and second auxiliary lights and make them proceed in the same direction as the main light.

Referring to FIG. 15, an illumination apparatus 88 according to a fifth exemplary embodiment of the invention is similar to the illumination apparatus 78 shown in FIG. 13 except that a light source section 251 includes first and second auxiliary light sources 80a and 80b, a third reflective prism 86, and an ultraviolet-cut filter 49 attached to a reflector 45. Here, the first and second auxiliary light sources 80a and 80b respectively come into close contact with a first end A and a second end A′ of the reflector 45, and the third reflective prism 86 is fixed to the ultraviolet-cut filter 49. In the illumination apparatus 88, a distance between the reflector 45 and the third reflective prism 86 is shorter than that in the illumination apparatus 78 shown in FIG. 13, thereby relatively reducing optical loss, and ultraviolet rays are cut out by the ultraviolet-cut filter 49, thereby improving the overall brightness. The ultraviolet-cut filter 49 may be further provided in any other exemplary embodiments to enlarge the color reproduction area over a screen and improve luminous efficiency.

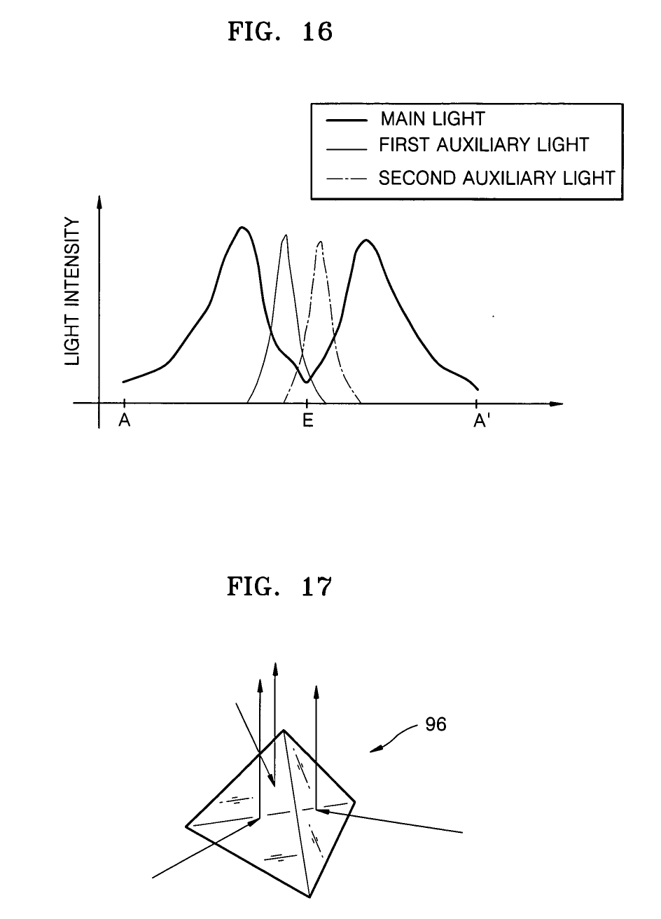

Referring to FIGS. 15 and 16, as the first and second auxiliary lights are reflected, respectively, by the first surface 86a and the second surface 86b of the prism 86, the graph shows peaks of the first and second auxiliary lights in the vicinity of the electrode E. As can be seen from the light intensity distribution graph, the illumination apparatus 88 using the plurality of auxiliary light source, can ensure a more uniform light intensity distribution than the illumination apparatuses 48 and 68 shown in FIGS. 5 and 11.

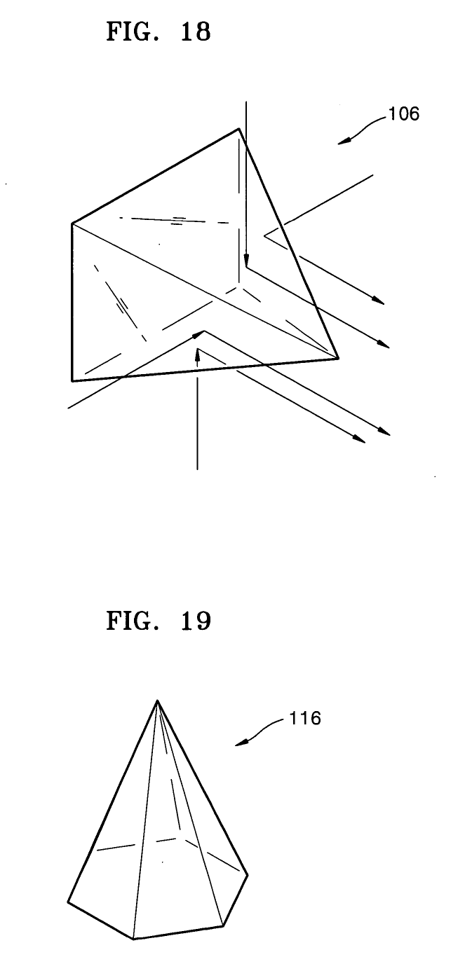

Referring to FIG. 17 through 19, the third reflective prism 86 shown in FIG. 15 may be replaced a tetrahedral-pyramidal prism 96, a pentahedral-pyramidal prism 106, or a reflective prism 116 having n (n>5) number of reflective surfaces. In this case, the tetrahedral pyramidal prism 96 has three surfaces of 45 degrees, and auxiliary light source section includes three auxiliary light sources, which are spaced apart from each other by 120 degrees. The tetrahedral-pyramidal prism 96 reflects first through third auxiliary lights emitted from the three auxiliary light sources to let them proceed in the same direction as main light.

When four auxiliary light sources are employed, the pentahedral-pyramidal prism 106 is used as a path changing member. In this manner, when n number of auxiliary light sources are employed, the reflective prism 116 having n (n>5) number of reflective surfaces can be used.

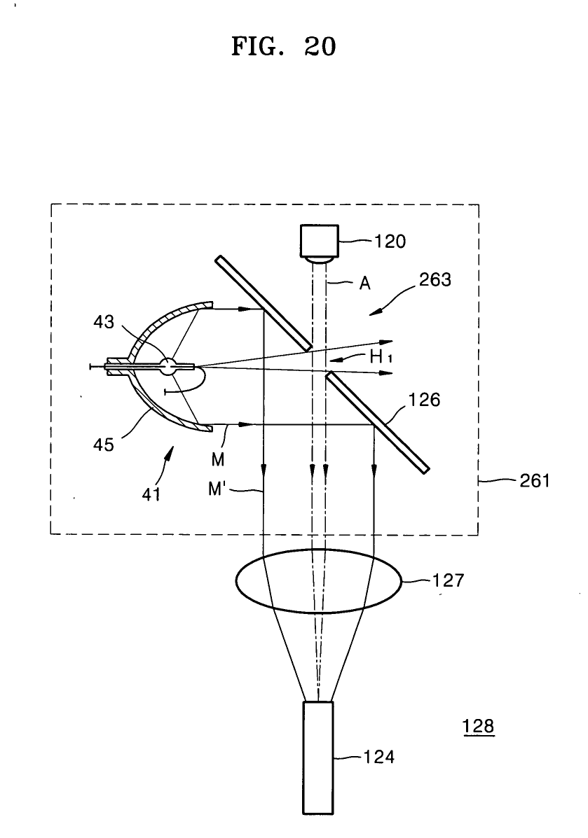

Referring to FIG. 20, an illumination apparatus 128 according to a sixth exemplary embodiment of the invention includes a main light source unit 41 for emitting main light M and an auxiliary light source unit 263 which includes an auxiliary light source 120 and a reflecting member. The auxiliary light source 120 is disposed at one side of the main light source unit 41 to emit auxiliary light perpendicularly to the main light M. For example, the reflecting member is a reflecting mirror 126 having a structure of plane plate. The reflecting mirror 126 has an aperture H1 formed therein for allowing the auxiliary light A to pass, and reflects the main light M to a direction parallel to the auxiliary light A so that the reflected main light M proceeds in the same direction as the auxiliary light A.

A condenser lens 127 is further provided in the path of the auxiliary light A and the reflected main light M, and light passing through the condenser lens 127 becomes uniform by use of a rod-type integrator 124.

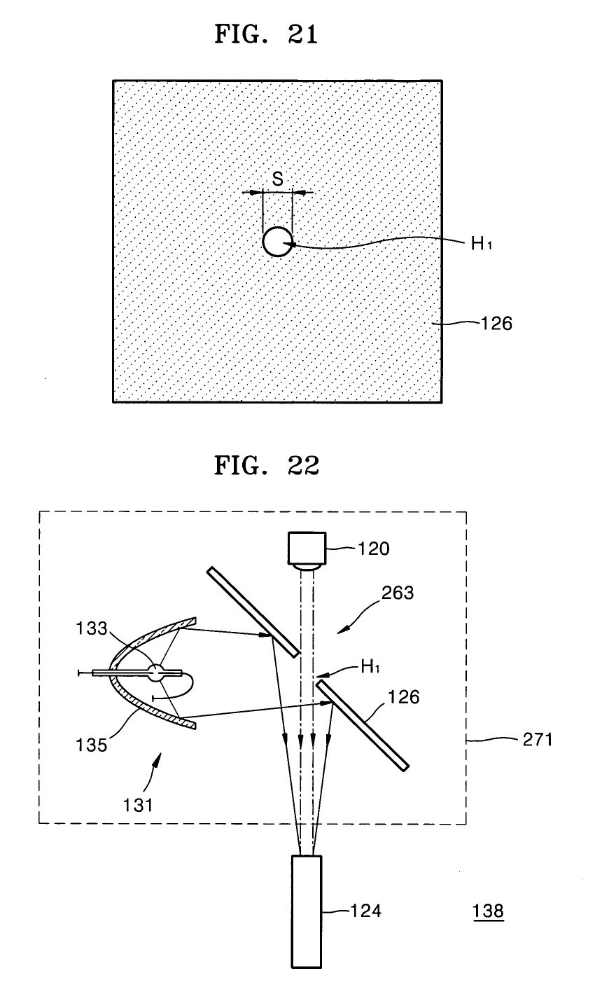

Referring to FIG. 21, the aperture H1 has a diameter S similar to the diameter of the flux of the auxiliary light A to effectively make the auxiliary light A proceed straight.

Referring to FIG. 22, an illumination apparatus 138 according to a seventh exemplary embodiment of the invention includes the same auxiliary light source unit 263 as that shown in FIG. 20 but includes a main light source unit 131 which is different from that shown in FIG. 20.

The main light source unit 131 includes a lamp 133 and an elliptical reflector 135 which reflects main light generated by the lamp 133. The elliptical reflector 135 emits light over a narrower solid angle than a parabolic reflector. The main light reflected by the elliptical reflector 135 is incident on the reflecting mirror 126 at an angle greater than 45 degrees and then reflected. Here, it is preferable that the auxiliary light source 120 is close to the main light source unit 131 to reduce optical loss.

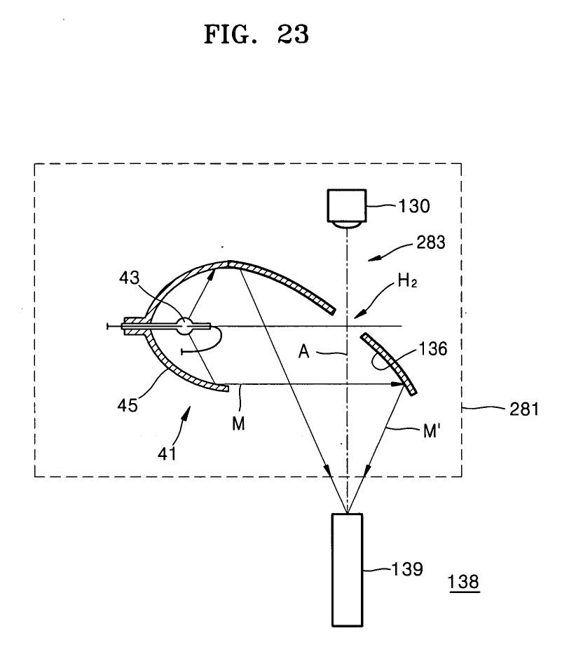

Referring to FIG. 23, an illumination apparatus 138 according to an eighth exemplary embodiment of the invention includes a light source section 281 and a rod-type integrator 139. The light source section 281 includes a main light source unit 41 and an auxiliary light source unit 283 disposed at one side of a path in front of the main light source unit 41. The auxiliary light source unit 283 includes a reflector member. Preferably, the reflector member is a spherical reflector 136 which has an aperture H2 for allowing auxiliary light A to proceed straight and a reflective surface 136a for reflecting main light M emitted from the main light source unit 41 to make a reflected main light M′ proceed in the same direction as the auxiliary light.

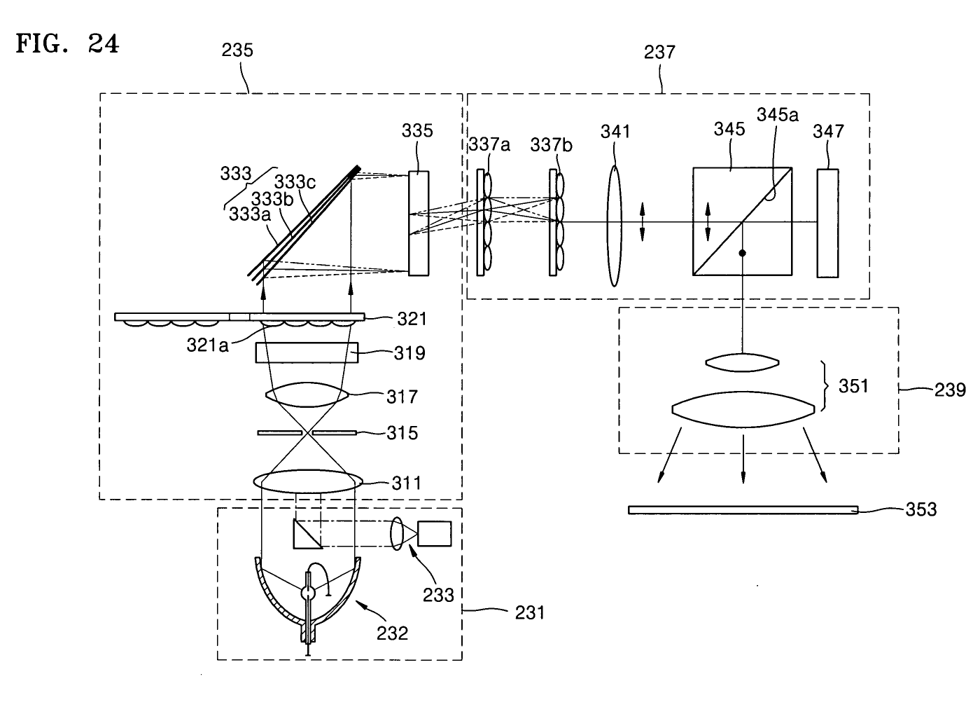

Referring to FIG. 24, the projection system according to a exemplary embodiment of the invention includes an illumination apparatus 231, an optical splitter 235 for separating light emitted from the illumination apparatus 231 into different-colored light corresponding to different wavelength bands, a display unit 237 for imaging the different-colored light according to applied image signals, and a projector 239 for projecting light emitted from the display unit 237 in an enlarged scale onto a screen 353.

The illumination apparatus 231 includes a main light source unit 232 for emitting white light, and an auxiliary light source unit 233 for emitting monochrome light in a wavelength band where optical loss occurs to increase the light and spectral intensities.

Here, the illumination apparatus 231 may be employ an apparatus selected from the illumination apparatuses according to the first through eighth exemplary embodiments and other illumination apparatuses within the scope of the invention.

The optical splitter 235 enables white light to have a uniform light intensity profile. The optical splitter 235 includes a plurality of dichroic filters 333, a first collimating lens 311 interposed between the illumination apparatus and the dichroic filters 333 for focusing light emitted from the illumination apparatus 231, a slit 315 for adjusting a divergent angle of the light focused by the first collimating lens 311, and a second collimating lens 317 for collimating light transmitted from the slit 315. The dichroic filters 333 reflect colored light exiting from the illumination apparatus 231 at different angles according to incident angles. Since the dichroic filters 333 transmit light of a predetermined wavelength band and reflects only light of predetermined bands, the number of dichroic filters provided is equal to the number of colors to be separated. In general, three dichroic mirrors 333a, 333b, and 333c as the dichroic filters 333 are provided to separate light into red, green, and blue.

Also, the optical splitter 235 further comprises a first cylindrical lens 319 and a scrolling lens 321 that are interposed between the second collimating lens 317 and the dichroic filters 333, and a second cylindrical lens 335. The first cylindrical lens 319 reduces the width of the light flux. The scrolling lens 321 scrolls through light transmitted from the first cylindrical lens 319 to change the path of the light in a predetermined cycle. A spiral lens disk formed by spirally arranging at least one cylindrical lens 321a can be used as the scrolling lens 321. The spiral lens disk enables a lens at a position where light passes to exhibit a straight-line motion effect using a rotation of a lens cell, so that light can be incident on different portions of the display unit 237. The second cylindrical lens 335 increases the width of the light flux passing through the dichroic filters 333 and returns the light to its original state.

Light passing through the optical splitter 235 proceeds to the display unit 237. The display unit 237 includes first and second fly-eye lenses 337a and 337b, a relay lens 341, a polarized beam splitter 345, and a light value 347. Different-colored light rays passing through the second cylindrical lens 335 are respectively focused on cells of the first and second fly-eye lenses 337a and 337b. The first and second fly-eye lenses 337a and 337b transmit the colored light rays with lens cells. The relay lens 341 superimposes the colored light rays and allows the colored light to proceed to the light valve 347.

Only one polarization of the light passing through the relay lens 341 is directed toward the light valve 347 by the polarized beam splitter 345. The polarized beam splitter 345 has a polarized light plane 345a to transmit the polarized light and reflects other light. Thus, the polarized beam splitter 345 can project the single polarized light onto the screen 353. The light valve 347 modulates the polarization of incident light according to image signals received to reflect the light by means of the polarized beam splitter 345. The light reflected by the polarized beam splitter 345 passes through a projector 239, in which a projection lens 351 is arranged parallel to the optical axis, to be projected onto the screen 353.

The illumination apparatus employing the auxiliary light source can control both the light intensity distribution and the spectral intensity of emitted light. The illumination apparatus installed in the projection system can enlarge an image and provide a high quality color reproduction with high luminous efficiency.

As described above, the illumination apparatus employing the auxiliary light source and the projection system comprising the illumination apparatus are advantageous in that uniform light intensity distribution can be obtained and full color reproduction of an image with high luminous efficiency can be realized.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

1. An illumination apparatus comprising:
a main light source unit for emitting white light; and
an auxiliary light source unit for introducing auxiliary light of a predetermined wavelength band to a space where the light intensity of the main light source unit is low.

2. The illumination apparatus of claim 1, wherein the arrangement of the auxiliary light source increases the overall light intensity of the illumination apparatus by augmenting the white light, and enlarges a color reproduction area.

3. The illumination apparatus of claim 1, wherein the main light source unit comprises:
a lamp for producing the white light; and
a reflector disposed around the lamp for reflecting and focusing the white light along a path.

4. The illumination apparatus of claim 3, wherein the main light source unit further comprises an ultraviolet-cut filter disposed in the path of the white light to cut out ultraviolet light.

5. The illumination apparatus of claim 4, wherein the main light source unit further comprises a collimating lens disposed on a central portion of the ultraviolet-cut filter to collimate the auxiliary light.

6. The illumination apparatus of claim 1, wherein the auxiliary light source unit comprises an auxiliary lamp for emitting the auxiliary light.

7. The illumination apparatus of claim 6, wherein the auxiliary lamp comprises a laser diode.

8. The illumination apparatus of claim 6, wherein the auxiliary lamp comprises a light emitting diode.

9. The illumination apparatus of claim 6, wherein the auxiliary lamp is directly attached to the main light source unit.

10. The illumination apparatus of claim 3, wherein the auxiliary light source unit comprises an auxiliary lamp for emitting the auxiliary light, and the auxiliary lamp is arranged on the main light source unit on a side of the lamp opposite the reflector.

11. The illumination apparatus of claim 6, wherein the auxiliary light source unit further comprises a light guide connected to the auxiliary lamp to guide the auxiliary light to the space in which the light intensity of the main light source unit is low.

12. The illumination apparatus of claim 3, wherein the auxiliary light source unit comprises an auxiliary lamp arranged near the main light source unit and a light source guide, wherein a first end of the light guide is connected to the auxiliary lamp, and a second end of the light guide is connected to the main light source unit at a point on a side of the lamp opposite the reflector.

13. The illumination apparatus of claim 11, wherein the light guide is a wave guide.

14. The illumination apparatus of claim 11, wherein the light guide is an optical fiber.

15. The illumination apparatus of claim 6, wherein the auxiliary light source unit further comprises a path changing member disposed in the space where the light intensity of the main light source unit is low to change a path of the auxiliary light.

16. The illumination apparatus of claim 15, wherein the path changing member is a prism having at least one reflective surface.

17. The illumination apparatus of claim 15, wherein:
the auxiliary lamp is arranged so that it emits auxiliary light in a first auxiliary light direction;
the first auxiliary light direction is different from a first white light direction of white light emitted from the lamp; and
the path changing member changes the path of the auxiliary light to a second auxiliary light direction similar to that of the first white light direction.

18. The illumination apparatus of claim 15, wherein the auxiliary light source unit further comprises a collimating lens between the auxiliary lamp and the path changing member.

19. The illumination apparatus of claim 6, wherein the auxiliary light source unit further comprises a plurality of auxiliary lamps and a path changing member.

20. The illumination apparatus of claim 19, wherein the path changing member:
comprises a number of reflecting surfaces equal to the number of auxiliary lamps; and
is disposed in the space where the light intensity of the main light source unit is low to change paths of auxiliary light emitted from each of the auxiliary lamps.

21. The illumination apparatus of claim 6, wherein the auxiliary light source unit further comprises a reflecting member comprising:
a reflecting surface for reflecting the white light emitted from the main light source unit; and
an aperture for allowing the auxiliary light emitted from the auxiliary lamp to pass through the reflecting member and for directing the auxiliary light so that it is introduced to the space in which the light intensity of the white light of the main light source unit is low.

22. The illumination apparatus of claim 21, wherein the reflecting member is a reflecting mirror.

23. The illumination apparatus of claim 21, wherein the reflecting member is a spherical reflector.

24. The illumination apparatus of claim 1, further comprising an integrator disposed in the path of the white light containing the auxiliary light for achieving uniform light intensity of the white light.

25. A projection system comprising:
an illumination apparatus;
an optical splitter for separating light emitted from the illumination apparatus into multiple-colored light;
a display unit for modulating and imaging the multiple-colored light emitted from the optical splitter according to applied image signals; and
a projector for projecting light emitted from the display unit on an enlarged scale onto a screen,
wherein the illumination apparatus comprises:
a main light source unit for emitting white light; and
an auxiliary light source unit for introducing auxiliary light of a predetermined wavelength band to a space where the light intensity of the main light source unit is low.

26. The projection system of claim 25, wherein the arrangement of the auxiliary light source increases the overall light intensity of the illumination apparatus by augmenting the white light, and enlarges a color reproduction area.

27. The projection system of claim 25, wherein the main light source unit comprises:
a lamp for producing the white light; and
a reflector disposed around the lamp for focusing the white light on a path.

28. The projection system of claim 27, wherein the main light source unit further comprises an ultraviolet-cut filter disposed in the path of the white light to cut out ultraviolet light.

29. The projection system of claim 28, wherein the main light source unit further comprises a collimating lens disposed at a central portion of the ultraviolet-cut filter to collimate the auxiliary light.

30. The projection system of claim 25, wherein the auxiliary light source unit comprises an auxiliary lamp for emitting the auxiliary light.

31. The projection system of claim 30, wherein the auxiliary lamp comprises a laser diode.

32. The projection system of claim 30, wherein the auxiliary lamp comprises a light emitting diode auxiliary lamp.

33. The projection system of claim 30, wherein the auxiliary lamp is directly attached to the main light source unit.

34. The projection system of claim 27, wherein the auxiliary light source unit comprises an auxiliary lamp for emitting the auxiliary light, and the auxiliary lamp is arranged on the main light source unit on a side of the lamp opposite the reflector.

35. The projection system of claim 30, wherein the auxiliary light source unit further comprises a light guide connected to the auxiliary lamp to guide the auxiliary light to the space in which the light intensity of the main light source unit is low.

36. The projection system of claim 27, wherein the auxiliary light source unit comprises an auxiliary lamp arranged near the main light source unit and a light source guide, wherein a first end of the light guide is connected to the auxiliary lamp, and a second end of the light guide is connected to the main light source unit at a point on a side of the lamp opposite the reflector.

37. The projection system of claim 35, wherein the light guide is a wave guide.

38. The projection system of claim 35, wherein the light guide is an optical fiber.

39. The projection system of claim 30, wherein the auxiliary light source unit further comprises a path changing member disposed at the space where the light intensity of the main light source unit is low to change a path of the auxiliary light.

40. The projection system of claim 39, wherein the path changing member is a prism having at least one reflective surface.

41. The projection system of claim 39, wherein:
the auxiliary lamp is arranged so that it emits auxiliary light in a first auxiliary light direction;
the first auxiliary light direction is different from a first white light direction of white light emitted from the lamp; and
the path changing member changes the path of the auxiliary light to a second auxiliary light direction similar to that of the first white light direction.

42. The projection system of claim 39, wherein the auxiliary light source unit further comprises a collimating lens between the auxiliary lamp and the path changing member.

43. The projection system of claim 30, wherein the auxiliary light source unit further comprises a plurality of auxiliary lamps and a path changing member.

44. The projection system of claim 43, wherein the path changing member:
comprises a number of reflecting surfaces equal to the number of auxiliary lamps; and
is disposed in the space where the light intensity of the main light source unit is low to change paths of auxiliary light emitted from each of the auxiliary lamps.

45. The projection system of claim 30, wherein the auxiliary light source unit further comprises a reflecting member comprising:
a reflecting surface for reflecting the white light emitted from the main light source unit; and
an aperture for allowing the auxiliary light emitted from the auxiliary lamp to pass through the reflecting member and for directing the auxiliary light so that it is introduced to the space in which the light intensity of the white light of the main light source unit is low.

46. The projection system of claim 45, wherein the reflecting member is a reflecting mirror.

47. The projection system of claim 45, wherein the reflecting member is a spherical reflector.

48. The projection system of claim 25, further comprising an integrator disposed in the path of the white light containing the auxiliary light for achieving a uniform light intensity of the white light.
